(19) United States
(12) Patent Application Publication
(10) Pub. No.: US 2024/0107441 A1
(43) Pub. Date: Mar. 28, 2024

(54) METHOD AND APPARATUS FOR MOBILITY MANAGEMENT OF INTERMITTENT CELL ACCESS IN COMMUNICATION SYSTEM

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yun Joo KIM, Daejeon (KR); Han Jun PARK, Daejeon (KR); Jung Bo SON, Daejeon (KR); An Seok LEE, Daejeon (KR); Yu Ro LEE, Daejeon (KR); Heesoo LEE, Daejeon (KR); Sung Cheol CHANG, Daejeon (KR)

(73) Assignee: ELECTRONICS AND TELECOMMUNICATIONS RESEARCH INSTITUTE, Daejeon (KR)

(21) Appl. No.: 18/475,154

(22) Filed: Sep. 26, 2023

(30) Foreign Application Priority Data
Sep. 28, 2022 (KR) 10-2022-0123740
Aug. 30, 2023 (KR) 10-2023-0114701

(51) Int. Cl. H04W 48/20; H04W 52/02; H04W 76/20

(52) U.S. Cl. CPC H04W 48/20; H04W 52/0206; H04W 76/20

(57) ABSTRACT

A method of a terminal may comprise: receiving a first message including state information of a base station from the base station; identifying preliminary inactive state information included in the first message when the state information of the base station indicates a preliminary inactive state; and performing a cell selection based on the preliminary inactive state information.

### CROSS-REFERENCE TO RELATED APPLICATIONS

This application claims priority to Korean Patent Applications No. 10-2022-0123740, filed on Sep. 28, 2022, and No. 10-2023-0114701, filed on Aug. 30, 2023, with the Korean Intellectual Property Office (KIPO), the entire contents of which are hereby incorporated by reference.

### BACKGROUND

### 1. Technical Field

Exemplary embodiments of the present disclosure relate to a method and an apparatus for mobility management in a communication system, and more specifically, to methods for managing mobility for intermittently-accessible cells rather than always-accessible cells, such as methods for cell selection/reselection and handover, and control techniques therefor.

### 2. Related Art

For the processing of rapidly increasing wireless data after commercialization of the 4G communication system (e.g., communication system supporting LTE), the 5G communication system (e.g., communication system supporting NR) using a frequency band (e.g., frequency band above 6 GHz) higher than a frequency band (e.g., frequency band below 6 GHz) of the 4G communication system as well as the frequency band of the 4G communication system is being considered. The 5G communication system can support enhanced Mobile BroadBand (eMBB), Ultra-Reliable and Low-Latency Communication (URLLC), and massive machine type communication (mMTC) scenarios. Discussions on the 6G communication system after the 5G communication system are in progress.

Meanwhile, the 5G communication system is known to consume more power than the 4G communication system. Since it uses a higher frequency than the 4G communication system and a radio wave coverage thereof is short, a larger number of base stations should be deployed. In addition, the base stations consume more power by using a plurality of antennas and extending a reach of radio waves by applying beamforming techniques or the like. According to the GSMA report, energy consumption of mobile communication networks accounts for 23% of total operator costs, and most of the energy consumption is reported to be consumed by radio access networks including the base stations.

The 3GPP starts standardization of techniques for reducing energy consumption of base stations, researches various techniques, and evaluates energy saving effects of the respective techniques. In addition, the 3GPP is in the process of standardizing procedures and techniques to efficiently provide the mobility of mobile base stations and the mobility of terminals accessing the base stations under a scenario in which the base stations are installed on vehicles such as buses and trains to provide user access services.

### SUMMARY

Exemplary embodiments of the present disclosure are directed to providing a mobility management method for accessing an intermittent cell in a communication system, and an apparatus therefor.

According to a first exemplary embodiment of the present disclosure, a method of a terminal may comprise: receiving a first message including state information of a base station from the base station; identifying preliminary inactive state information included in the first message when the state information of the base station indicates a preliminary inactive state; and performing a cell selection based on the preliminary inactive state information.

The preliminary inactive state information may include at least one of an inactive state start time, an inactive state duration time, or a preliminary inactive offset.

When the preliminary inactive state information includes the preliminary inactive offset, a cell may be selected in consideration of the preliminary inactive offset.

The method may further comprise: identifying inactive state information included in the first message when the state information of the base station indicates an inactive state; and performing a cell selection based on the inactive state information.

The inactive state information may include at least one of an inactive state start time, an inactive state duration time, an active state start time, or an inactive offset.

When inactive state information includes the inactive offset, a cell may be selected in consideration of the inactive offset.

The method may further comprise: identifying energy saving state information included in the first message when the state information of the base station indicates an energy saving state; and performing a cell selection based on the energy saving state information.

The energy saving state information may include at least one of an energy saving offset or an energy saving scheme.

When the energy saving state information may include the energy saving offset, a cell may be selected in consideration of the energy saving offset.

The method may further comprise: generating a first message for notifying that there is no other cell that satisfies cell selection criteria when there is no other cell that satisfies the cell selection criteria except for the base station to which the terminal is currently accessing; and transmitting the first message to the base station.

According to a second exemplary embodiment of the present disclosure, a method of a base station may comprise: generating a first message including state information of the base station; and transmitting the first message to a terminal, wherein when the state information of the base station indicates a preliminary inactive state, the first message may include at least one of an inactive state start time, an inactive state duration time, or a preliminary inactive offset.

When the state information of the base station indicates an inactive state, the first message may include at least one of an inactive state start time, an inactive state duration time, an active state start time, or an inactive offset for cell selection.

When the state information of the base station indicates an energy saving state, the first message may include at least one of an energy saving offset or an energy saving scheme.

The first message may be at least one of a system information message broadcast by the base station, a system message transmitted to the terminal, or a dedicated message transmitted to the terminal.

According to a third exemplary embodiment of the present disclosure, a terminal may comprise a processor, and the processor may cause the terminal to perform: receiving a first message including state information of a base station from the base station; identifying preliminary inactive state information included in the first message when the state information of the base station indicates a preliminary inactive state; and performing a cell selection based on the preliminary inactive state information.

The preliminary inactive state information may include at least one of an inactive state start time, an inactive state duration time, or a preliminary inactive offset.

The processor may further cause the terminal to perform: identifying inactive state information included in the first message when the state information of the base station indicates an inactive state; and performing a cell selection based on the inactive state information.

The inactive state information may include at least one of an inactive state start time, an inactive state duration time, an active state start time, or an inactive offset.

The processor may further cause the terminal to perform: identifying energy saving state information included in the first message when the state information of the base station indicates an energy saving state; and performing a cell selection based on the energy saving state information.

The energy saving state information may include at least one of an energy saving offset or an energy saving scheme.

Using the exemplary embodiments of the present disclosure, a terminal can perform cell selection/reselection and handover, reduce unnecessary handovers, and minimize communication quality degradation by enabling access to an optimal cell based on preliminary inactive state information, inactive state information, or energy saving state information of a base station. In addition, the terminal can improve communication quality by performing the cell selection/reselection and handover, reducing unnecessary handovers, and minimizing communication quality degradation based on the preliminary inactive state information, inactive state information, or energy saving state information of the base station.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating operation states of a base station for energy saving according to an exemplary embodiment of the present disclosure.

FIG. 4 is a sequence chart illustrating an improved method of accessing a base station by a terminal according to an exemplary embodiment of the present disclosure.

FIG. 5 is a sequence chart illustrating a procedure for reporting communication quality degradation of a terminal in an energy saving state of a base station according to an exemplary embodiment of the present disclosure.

FIG. 6 is a sequence chart illustrating a procedure for accessing a base station installed in a vehicle by a terminal according to a first exemplary embodiment of the present disclosure.

FIG. 7 is a sequence chart illustrating a procedure for accessing a base station installed in a vehicle by a terminal according to a second exemplary embodiment of the present disclosure.

FIG. 8 is a sequence chart illustrating a procedure for accessing a base station installed in a vehicle by a terminal according to a third exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

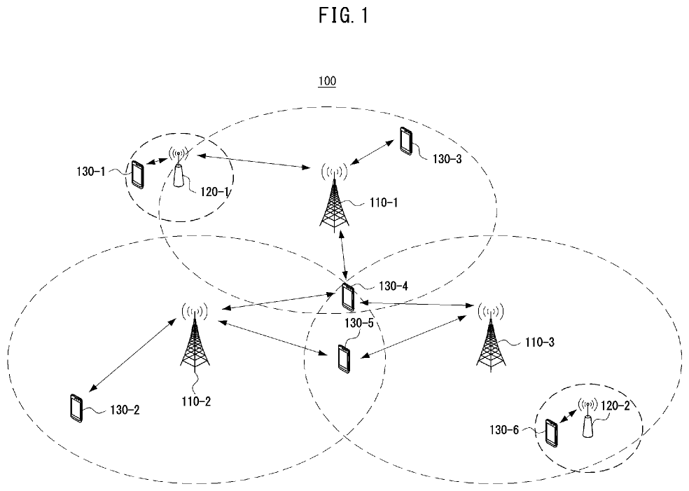

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

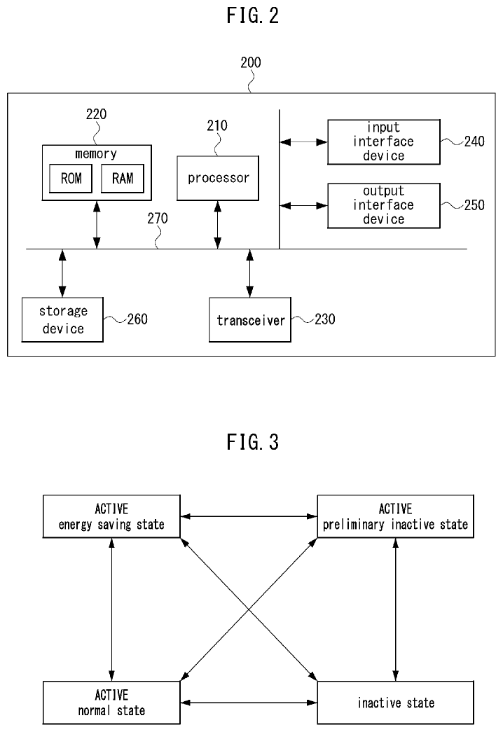

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, mobility management methods and apparatuses in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions of a communication protocol (e.g., a remote radio transmission/reception function and a baseband processing function). Alternatively, the remote radio transmission and reception function among all functions of the communication protocol may be performed by transmission and reception point(s) (TRP(s)) (e.g., flexible (f)-TRP), and the baseband processing function among all functions of the communication protocol may be performed by a baseband unit (BBU) block. The TRP may be a remote radio head (RRH), radio unit (RU), transmission point (TP), and/or the like. The BBU block may include at least one BBU or at least one digital unit (DU). The BBU block may be referred to as a ‘BBU pool’, ‘centralized BBU’, or the like. The TRP may be connected to the BBU block via a wired fronthaul link or a wireless fronthaul link. A communication system composed of a backhaul link and a fronthaul link may be as follows. When a functional split scheme of the communication protocol is applied, the TRP may selectively perform some functions of the BBU or some functions of a medium access control (MAC) layer and/or a radio link control (RLC) layer.

Methods for Providing Inactive State Information of a Base Station

As communication technology evolves recently, power consumption in a network continues to increase. In order to meet the rapidly increasing data traffic demand, communication systems should consume a significant amount of energy, increasing the operator's operational expenditure (OPEX) as well as increasing greenhouse gas emissions. Therefore, due to economic and environmental reasons, network energy saving (NES) has become an important consideration.

FIG. 3 is a conceptual diagram illustrating operation states of a base station for energy saving according to an exemplary embodiment of the present disclosure.

Referring to FIG. 3, operation states of a base station for energy saving may be classified into an ACTIVE normal state, an ACTIVE energy saving state, an ACTIVE preliminary inactive state, and an INACTIVE state. The ACTIVE normal state may be referred to as an active state, the ACTIVE energy saving state may be referred to as an energy saving state, and the ACTIVE preliminary inactive state may be referred to as a preliminary inactive state.

The ACTIVE normal state is a generally expressed active state, and may mean a state in which the base station does not perform any operations to save energy. For example, in the ACTIVE normal state, the base station may communicate with terminals belonging to the base station using the entire bandwidth available to the base station. In addition, when a specific terminal performs a handover from another base station to the corresponding base station as a target base station, there may be no restrictions. It should be noted that the above description of the ACTIVE normal state is merely one example without being limited thereto.

The ACTIVE energy saving state may refer to a case in which operations for energy saving are performed even in the active state. For example, the ACTIVE energy saving state may be a state in which use of a portion of the entire bandwidth available to the base station is restricted. As another example, the ACTIVE energy saving state may be a state of limiting the maximum transmit power of the base station. It should be noted that what has been described above is intended to describe an example of the ACTIVE energy saving state, and the ACTIVE energy saving state is not limited thereto or limited to these factors.

The ACTIVE preliminary inactive state may be a case in which a current state of the base station is the active state, but it is notified that the base station is to transition to the inactive state after a predetermined time. Therefore, it may mean a state for allowing terminals belonging to the base station in the ACTIVE preliminary inactive state to access another base station. It should be noted that what has been described above is intended to describe an example of the ACTIVE preliminary inactive state, and the ACTIVE preliminary inactive state is not limited thereto.

The base station operating in the active state may transition to the energy saving state in which some functions are not performed even though the base station is in the active state. Alternatively, the base station may operate by transitioning from the active state to the inactive state in which almost all functions are not performed. The base station may operate in the preliminary inactive state in which it remains in the active state to facilitate smooth disconnections of terminals belonging to the base station before transitioning to the inactive state. In the preliminary inactive state, cell access may be limitedly allowed for the smooth disconnections.

The base station may provide inactive state information to terminal(s). The base station may include the inactive state information in system information broadcasted to the entire cell. Alternatively, the base station may transmit system information including the inactive state information to specific terminal(s). As another method, the base station may transmit a message including the inactive state information to terminal(s). Here, the system information may be a system information block 1 (SIB1). The base station may use other message(s) as needed.

The base station may provide terminal(s) with the inactive state information as preliminary inactive state information before operating in the inactive state. The preliminary inactive state information may be included in information element(s) (IE(s)) related to cell access (e.g., IE(s) of SIB1). A flag indicating the preliminary inactive state may be set to ‘true’.

Table 1 shows an example of preliminary inactive state information.

TABLE 1

| | Fields | Description |
|---|---|---|
| Preliminary | Inactive state start time | Represented as UTC |
| inactive state | Inactive state duration time | Represented in unit times |
| information | Preliminary inactive offset | Applied as a cell selection/ |
| | | reselection criterion |

Referring to Table 1, the preliminary inactive state information may include an inactive state start time, an inactive state duration time, and a preliminary inactive offset (e.g., prelnactiveOffset). The inactive state start time may be represented as a UTC time, and the inactive state duration time may be represented in unit times. The terminal may apply the preliminary inactive offset (e.g., preInactiveOffset) as a cell selection or reselection criterion.

When operating in the inactive state, the base station may provide inactive state information to the terminal. The inactive state information may be included in information element(s) related to cell access. A flag indicating the inactive state may be set to ‘true’. A cell operating in the inactive state may be a reserved cell that does not allow access of terminals except for exceptional cases. In another case, a cell operating in the inactive state may be in a cell state allowing limited access of terminals.

Table 2 shows an example of inactive state information.

TABLE 2

| | Fields | Description |
|---|---|---|
| Inactive state | Inactive state start time | Represented as UTC |
| information | Inactive state duration time | Represented in unit times |
| | Active state start time | Represented as UTC |
| | Inactive offset | Applied as a cell selection/ |
| | | reselection criterion |

Referring to Table 2, the inactive state information may include an inactive state start time, an inactive state duration time, and an inactive offset (e.g., inactiveOffset). The inactive state start time may be represented as a UTC time, and the inactive state duration time may be represented in unit times. The terminal may apply the inactive offset (e.g., inactiveOffset) as a cell selection or reselection criterion.

When operating in the energy saving state, the base station may provide energy saving state information to terminal(s). The base station may include the energy saving state information in system information (e.g., SIB1) broadcasted to the entire cell. Alternatively, the base station may transmit system information including the energy saving state information to specific terminal(s). As another method, the base station may transmit a message including the energy saving state information to terminal(s).

When operating in the energy saving state, the base station may provide the energy saving state information to terminal(s). The energy saving state information may be included in information element(s) related to cell access. A flag indicating the energy saving state may be set to ‘true’. A cell operating in the energy saving state may be a cell allowing limited access of terminal(s).

Table 3 shows an example of energy saving state information.

TABLE 3

| | Fields | Description |
|---|---|---|
| Energy saving | Energy saving | Applied as a cell selection/ |
| state | offset | reselection criterion |
| information | Energy saving | Applied energy saving |
| | scheme | scheme |

Referring to Table 3, the energy saving state information may include an energy saving offset (e.g., energySavingOffset) and an applied energy saving scheme. The terminal may apply the energy saving offset (e.g., energySavingOffset) as a cell selection or reselection criterion. The energy saving scheme may indicate an applied energy saving scheme, and may indicate at least one of a time domain scheme, frequency domain scheme, space domain scheme, or power domain scheme.

The base station operating in the energy saving state may receive a report from a terminal when a communication quality of the terminal deteriorates, and may adjust the energy saving state as needed.

Improved Methods for a Terminal to Access a Base Station

Based on system information received from a base station, a terminal may determine whether or not to access another base station. The terminal may transmit a message indicating that the terminal cannot access another base station in a base station access procedure to be described below.

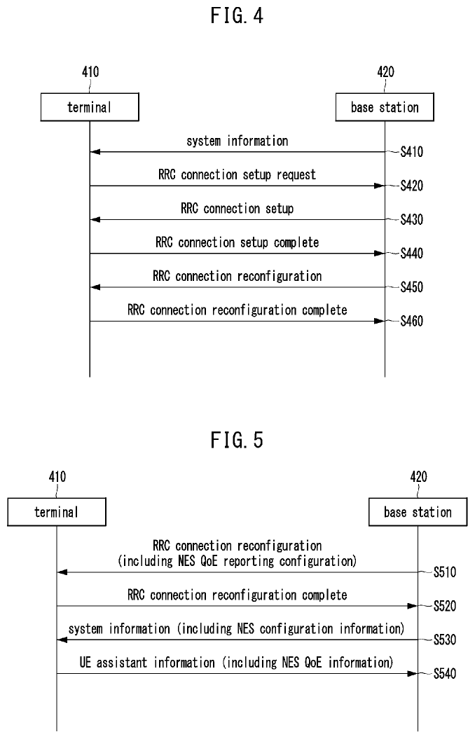

FIG. 4 is a sequence chart illustrating an improved method of accessing a base station by a terminal according to an exemplary embodiment of the present disclosure.

Referring to FIG. 4, a communication system may include a terminal 410 and a base station 420. The terminal 410 may be the terminal 130-1, 130-2, 130-3, 130-4, 130-5, or 130-6 shown in FIG. 1, and the base station 420 may be the base station 110-1, 110-2, 110-3, 120-1, or 120-2 shown in FIG. 1. The terminal 410 and the base station 420 may be configured identically or similarly to the communication node shown in FIG. 2. The terminal 410 may receive system information from the base station 420, and identify information related to cell access. When cell access is possible, the terminal 410 may access the base station 420 through an RRC connection establishment procedure. When the terminal 410 accesses the base station 420 operating in the inactive state or the preliminary inactive state, another cell that satisfies cell selection criteria may not exist. In this case, the terminal 410 may transmit an RRC message including information indicating that there is no other accessible cell to the base station 420. When the base station 420 receives the information indicating there is no other accessible cell from the terminal 410, the operation state of the base station may transition from the inactive state or preliminary inactive state to the active state as needed.

In a step S410, the terminal 410 may receive system information (e.g., SIB1) from the base station 420. The terminal 410 may select a cell based on the received system information. Here, the system information may include offset information (e.g., preliminary inactive offset or inactive offset) that is considered during cell selection.

In the preliminary inactive state, the base station may generate a message indicating the preliminary inactive state and including preliminary inactive state information, and transmit the message to terminal(s) through system information. The preliminary inactive state information transmitted by the base station through system information may include, for example, at least one of the information in Table 1 described above. In other words, the preliminary inactive state information may include at least one of the inactive state start time, inactive state duration time, or preliminary inactive offset. Here, the system information may be at least one of a system information message broadcast by the base station, a system message transmitted to terminal(s), and a dedicated message transmitted to terminal(s).

The terminal may receive the system information indicating the preliminary inactive state from the base station, and identify the preliminary inactive state information included in the system information. The terminal may select a cell based on the preliminary inactive state information. That is, when the preliminary inactive state information includes the preliminary inactive offset (e.g., prelnactiveOffset), the terminal may select a cell by considering the preliminary inactive offset during cell selection. On the other hand, when the preliminary inactive state information does not include the preliminary inactive offset (e.g., preInactiveOffset), the terminal may consider a predetermined value during cell selection.

Meanwhile, if there is no other cell that satisfies the cell selection criteria during cell selection, the preliminary inactive offset may not be applied as a cell selection criterion. In addition, a predetermined value may not be applied as a cell selection criterion.

In the inactive state, the base station may generate a system information message (e.g., SIB1) indicating the inactive state and including inactive state information to terminal(s). The inactive state information transmitted by the base station through system information may include, for example, at least one of the information in Table 2 described above. In other words, the inactive state information may include at least one of the inactive state start time, inactive state duration time, active state start time, or inactive offset.

The terminal may receive the system information indicating the inactive state from the base station, and identify the inactive state information included in the system information. The terminal may select a cell based on the inactive state information. That is, when the inactive state information includes the inactive offset (e.g., inactiveOffset), the terminal may select a cell by considering the inactive offset during cell selection. On the other hand, when the inactive state information does not include the inactive offset, the terminal may consider a predetermined value during cell selection.

Meanwhile, if there is no other cell that satisfies the cell selection criteria during cell selection, the inactive offset may not be applied as a cell selection criterion. In addition, a predetermined value may not be applied as a cell selection criterion.

In a step S420, the terminal 410 may transmit an RRC connection setup request message (e.g., RRCSetupRequest message) to the base station 420 according to a random access procedure. The base station 420 may receive the RRC connection setup request message from the terminal 410.

In a step S430, the base station 420 may transmit an RRC connection setup message (e.g., RRCSetup message) to the terminal 410 in response to the received RRC connection setup request message. The terminal 410 may receive the RRC connection setup message from the base station 420.

In a step S440, the terminal 410 may establish an RRC connection with the base station 420 based on the received RRC connection setup message. When the RRC connection establishment is completed, the terminal 410 may transmit an RRC connection setup complete message (e.g., RRCSetupComplete message) to the base station 420. The base station 420 may receive the RRC connection setup complete message from the terminal 420.

After the RRC connection between the terminal 410 and the base station 420 is established, the base station 420 may reconfigure the RRC connection with the terminal as needed.

In a step S450, the base station 420 may transmit an RRC connection reconfiguration message (e.g., RRCReconfiguration message) for reconfiguring the RRC connection to the terminal 410. The terminal may receive the RRC connection reconfiguration message from the base station.

In a step S460, the terminal 410 may reconfigure the RRC connection with the base station based on the received RRC connection reconfiguration message. In response to the RRC connection reconfiguration, the terminal may transmit an RRC connection reconfiguration complete message (e.g., RRCReconfigurationComplete message) to the base station.

When accessing the base station operating in the inactive state or in the preliminary inactive state, the terminal may identify whether another cell that satisfies the cell selection criteria exists. If there is no other cell that satisfies the cell selection criteria, the terminal may inform the base station of this.

As an exemplary embodiment, the terminal may set information (e.g., noOtherSuitableCell) informing the base station that there is no cell that satisfies the cell selection criteria to ‘true’, and may transmit it by including it in the RRC connection setup complete message.

As another exemplary embodiment, the terminal may set information (e.g., noOtherSuitableCell) informing the base station that there is no cell that satisfies the cell selection criteria to ‘true’, and may transmit it by including it in the RRC connection setup request message or RRC reconfiguration complete message.

As yet another exemplary embodiment, the terminal may set information (e.g., noOtherSuitableCell) informing the base station that there is no cell that satisfies the cell selection criteria to ‘true’, and may transmit it by including it in an RRC UE assistance information message or another RRC message.

The base station may receive, from the terminal, the RRC message including information informing that there is no cell that satisfies the cell selection criteria. The base station may stop operations according to the inactive state or preliminary inactive state as needed, and may transition to operate in the active state. Here, the RRC message may be one of the RRC connection setup request message, RRC connection setup complete message, RRC reconfiguration complete message, RRC UE assistance information message, or other RRC messages.

Meanwhile, the base station may operate in the inactive state, and a terminal may attempt to access the base station. Here, the base station may operate a reserved cell that does not allow access of terminal(s) except in exceptional cases. In the following cases, the terminal may access or attempt to access the base station.
When attempting an emergency call, the terminal may access the base station operating in the inactive state;
Based on an assigned access identity (AI), the terminal may access the base station operating in the inactive state;
When attempting to exceptionally access an existing reserved cell, the terminal may access the base station operating in the inactive state;
When the base station operates in the inactive state and operates a cell allowing exceptional access of terminal(s), the terminal may attempt to access the base station.

Based on a message (e.g., RRC message) received from the terminal, the base station may request another base station operating in the inactive state to transition to the active state as needed.

For example, a base station A may be connected to a terminal, and a base station B may operate in the inactive state. The base station B may operate a reserved cell that does not allow access of terminal(s) except in an exceptional case. When it is determined that access to the base station B is required, the terminal may transmit a message indicating that the base station B operates in the inactive state and operates a reserved cell to the base station A. Upon receiving the corresponding message from the terminal, the base station A may request the base station B to transition from the inactive state to the active state as needed.

The base station may provide energy saving state information to terminal(s). The base station may include the energy saving state information in system information broadcasted to the entire cell. Alternatively, the base station may transmit system information including the energy saving state information to specific terminal(s). As another method, the base station may transmit a message including the energy saving state information to terminal(s). Here, the system information may be a SIB1. The base station may use other messages as needed.

The terminal may receive the energy saving information from the base station. When the received energy saving information includes an energy saving offset (e.g., energySavingOffset) applicable as a cell selection criterion, the terminal may apply the energy saving offset as a cell selection criterion. When the received energy saving information does not include the energy saving offset (e.g., energySavingOffset) applicable as a cell selection criterion, the terminal may use a predetermined value as the energy saving offset and apply it as a cell selection criterion. During cell selection, if there is no other cell that satisfies the cell selection criteria, the terminal may not apply the energy saving offset as a cell selection criterion.

In the energy saving state, the base station may generate a system information message (e.g., SIB1) indicating the energy saving state and including the energy saving state information, and transmit the system information message to the terminal. The energy saving state information transmitted by the base station through the system information may include, for example, at least one of the information in Table 3 described above. In other words, the energy saving state information may include at least one of the energy saving offset or energy saving scheme.

The terminal may receive the system information indicating the energy saving state from the base station, and identify the energy saving state information included in the system information. The terminal may select a cell based on the energy saving state information. That is, when the energy saving state information includes the energy saving offset (e.g., energySavingOffset), the terminal may select a cell by considering the energy saving offset during cell selection. On the other hand, when the energy saving state information does not include the energy saving offset, the terminal may consider a predetermined value during cell selection.

Meanwhile, if there is no other cell that satisfies the cell selection criteria during cell selection, the terminal may not apply the energy saving offset as a cell selection criterion. In addition, a predetermined value may not be applied as a cell selection criterion.

When operating in the energy saving state, the base station may receive a report on communication quality deterioration from terminal(s). When a communication quality is degraded, terminal(s) may report the deterioration of the communication quality to the base station based on the received energy saving state information. When a different in transmission rate before and after the base station operates in the energy saving state is greater than a specific threshold, the terminal(s) may report this to the base station. The base station may limit the reporting of communication quality degradation to only terminals having a low movement speed in consideration of mobility. When operating in the energy saving state, the base station may receive a report of communication quality deterioration from terminal(s) through the following procedure.

FIG. 5 is a sequence chart illustrating a procedure for reporting communication quality degradation of a terminal in an energy saving state of a base station according to an exemplary embodiment of the present disclosure.

Referring to FIG. 5, the base station 420 may configure the terminal 410 to report communication quality degradation when a communication quality is degraded in the energy saving state. In addition, the base station 420 may transmit energy saving state configuration information to the terminal 410. When the base station 420 operates in the energy saving state, the terminal 410 may report communication quality degradation to the base station 420. For convenience of description, although a procedure for the terminal 410 to receive system information from the base station 420 and establish an RRC connection with the base station is not described, the terminal 410 may perform a step (e.g., S410) of receiving system information from the base station 420 and step(s) (e.g., S420 to S440) for RRC connection establishment.

In a step S510, the base station 420 may transmit an RRC reconfiguration message (e.g., RRCReconfiguration message) including communication quality degradation reporting configuration information (e.g., nesQoEReportingConfig) to the terminal 410 for the energy saving state. The terminal 410 may receive the RRC reconfiguration message including the communication quality degradation reporting configuration information from the base station 420 for the energy saving state. Here, the RRC reconfiguration message may be a modified message or a newly defined message including the communication quality degradation reporting configuration information.

In a step S520, the terminal 410 may be configured to report communication quality degradation based on the received RRC reconfiguration message. The terminal 410 may transmit an RRC reconfiguration complete message (e.g., RRCReconfigurationComplete message) to the base station 420 in response to the RRC connection reconfiguration.

In a step S530, the base station 420 may transmit system information (e.g., SIB1) including energy saving state configuration information (e.g., NESConfig) to the terminal 410. The terminal 410 may receive the system information including the energy saving state configuration information from the base station 420. Here, the system information may be a modified message or a newly defined message including the energy saving state configuration information.

In a step S540, the terminal 410 may determine whether a communication quality is degraded based on the communication quality degradation reporting configuration information and the energy saving state configuration information received from the base station 420. In case of communication quality degradation, the terminal 410 may transmit a UE assistance information message (e.g., UEAssistanceInformation message) including communication quality information (e.g., nesQoEInformation) to the base station 420. Here, the UE assistance information message may be a modified message or a newly defined message including the communication quality information.

The above-described methods applied to cell selection procedures may also be applied to cell reselection procedures.

Methods for Providing Base Station Movement State Information for a Moving Base Station

The base station may provide base station movement state information to terminal(s). As one method, the base station may include the base station movement state information in system information broadcasted to the entire cell. Alternatively, the base station may transmit system information including the base station movement state information to specific terminal(s). Alternatively, the base station may transmit a message including the base station movement state information to terminal(s). Here, the system information may be a SIB1. Other messages may be used as needed. Also, the base station may be a base station installed in a vehicle (e.g., a bus, train, high-speed rail, etc.). The system information may be a modified message or a newly defined message including the base station movement state information.

When the base station is in a moving state, the base station may provide the base station movement state information to terminal(s). The base station movement state information may be included in information element(s) related to cell access, and a flag indicating the moving state of the base station may be set to ‘true’. As an exemplary embodiment, a cell whose base station is in the moving state may be a reserved cell that does not allow access of other terminals except for terminal(s) boarding the vehicle. In another exemplary embodiment, a cell whose base station is in the moving state may be in a cell state in which limited access of terminal(s) is allowed.

Table 4 shows an exemplary embodiment of base station movement state information.

TABLE 4

| | Fields | Description |
|---|---|---|
| Base station | Current location | Current location of the vehicle in |
| movement state | of the vehicle | which the base station is installed |
| information | Movement speed | Movement speed of the vehicle in |
| | of the vehicle | which the base station is installed |
| | Cell coverage | — |
| | Surrounding | Applied as a cell selection or |
| | offset | reselection criterion |
| | Surrounding | Applied as a signal measurement |
| | connected offset | event determination criterion |

Referring to Table 4, the base station movement state information may include a current location of the vehicle, movement speed of the vehicle, cell coverage, surrounding offset (e.g., surroundingOffset), and surrounding connected offset (e.g., surroundingConnectedOffset).

The base station may provide a changed current location of the vehicle to terminal(s) as the base station movement state information periodically or when the amount of location change is greater than a specific threshold.

The base station may provide a changed movement speed of the vehicle to terminal(s) as the base station movement state information periodically or when the amount of movement speed change of the vehicle is greater than a specific threshold.

When the base station is in a moving state, a terminal that does not board the vehicle or a terminal that is determined not to board the vehicle may apply the surrounding offset (e.g., surroundingOffset) included in the base station movement state information as a cell selection or reselection criterion.

When the base station is in a moving state, a terminal that does not board the vehicle or a terminal that is determined not to board the vehicle may apply the surrounding connected offset (e.g., surroundingConnectedOffset) included in base station movement state information as a signal measurement event determination criterion.

The base station movement state information may include information capable of determining whether the terminal is a terminal boarding the vehicle in an idle state or an inactive state. The base station movement state information may include information capable of determining whether the terminal is a terminal boarding the vehicle in a connected state. Here, the idle state, the inactive state, and the connected state may mean RRC connection states between the terminal and the moving base station.

Improved Method for a Terminal to Access a Moving Base Station

The terminal may receive base station movement state information from a moving base station, and the received base station movement state information may include the surrounding offset (e.g., surroundingOffset) applicable as a cell selection criterion. The terminal may apply the received base station movement state information as a cell selection criterion. The terminal may use a predetermined value when the surrounding offset is not included in the base station movement state information. When the terminal performs cell selection, if there is no other cell that satisfies the cell selection criteria, the terminal may not apply the surrounding offset as a cell selection criterion. The surrounding offset may be applied as a cell selection criterion only to a terminal that does not board the vehicle or a terminal that is determined not to board the vehicle. Here, the vehicle may refer to a moving object (e.g., a bus, train, high-speed rail, etc.) on which the base station is mounted, and the mounted base station may be a moving base station.

In the idle state (e.g., RRC idle state) or inactive state (e.g., RRC inactive state), the terminal may receive the base station movement state information from the moving base station. The received base station movement state information may include information capable of determining whether the terminal boards the vehicle.

As a method, when a change in a cell selection reception level (e.g., Srxlev) of the corresponding base station is less than or equal to a threshold for a predetermined time while the base station is moving, the terminal may be determined to be a terminal boarding the vehicle. For example, when Equation 1 below is satisfied, the terminal may be a terminal boarding the vehicle.

isMobileCell AND [(Srxlev_{Ref}−Srxlev)<S_{SearchDeltaP}] [Equation 1]

Here, isMobileCell indicates whether the base station is in a moving state, Srxlev_{Ref} indicates a reference cell selection reception level, and Srxlev indicates a cell selection reception level of the base station. In addition, S_{SearchDeltaP} represents a threshold for a difference between Srxlev_{Ref} and Srxlev.

The reference cell selection reception level (e.g., Srxlev_{Ref}) may be set to a current cell selection reception level (e.g., Srxlev) after cell selection. Alternatively, the reference cell selection reception level (e.g., Srxlev_{Ref}) may be set to a value of the current cell selection reception level (e.g., Srxlev) when Equation 1 is not satisfied for a predetermined time.

As another method, when a change in a difference (e.g., Ldiff) between a current location of the corresponding base station and a current location of the terminal while the base station is moving is less than or equal to a threshold for a predetermined time, the terminal may be determined to be a terminal boarding the vehicle. For example, when Equation 2 below is satisfied, the terminal may be a terminal boarding the vehicle.

isMobileCell AND [(Ldiff_{Ref}−Ldiff)<L_{SearchDeltaP}] [Equation 2]

Here, isMobileCell indicates whether the base station is in a moving state, Ldifff_{Ref} indicates a reference Ldiff, and Ldiff indicates a difference between the current location of the base station and the current location of the terminal. In addition, L_{SearchDeltaP} represents a threshold for a difference between Ldifff_{Ref} and Ldiff.

As yet another method, when both a cell selection reception level change condition and a location difference change condition are satisfied, or only one of the cell selection reception level change condition and the location difference change condition is satisfied, the terminal may be determined to be a terminal boarding the vehicle. Here, the cell selection reception level change condition may be the condition shown in Equation 1, and the location difference change condition may be the condition shown in Equation 2.

The base station may transmit the base station movement state information to terminal(s), and the terminal(s) may receive the base station movement state information from the base station. The base station movement state information may include the surrounding connected offset (e.g., surroundingConnectedOffset) applicable as a signal measurement event determination criterion. The terminal may apply the surrounding connected offset included in the base station movement state information as a signal measurement event determination criterion. In addition, the terminal may use a predetermined value when the base station movement state information does not include the surrounding connected offset. The surrounding connected offset may be applied as signal measurement event determination criterion only for a terminal that does not board the vehicle or a terminal that is determined not to board the vehicle.

The terminal may receive the base station movement state information from the base station in the connected state (e.g., RRC connected state), and the base station movement state information may include information for determining whether or not the terminal boards the vehicle.

The base station installed in the vehicle may transmit, to an accessing terminal, configuration information for configuring the accessing terminal to report a result of determining whether or not the terminal boards the vehicle. When the terminal determines that the terminal boards the vehicle, the terminal may transmit boarding information to the base station as follows.

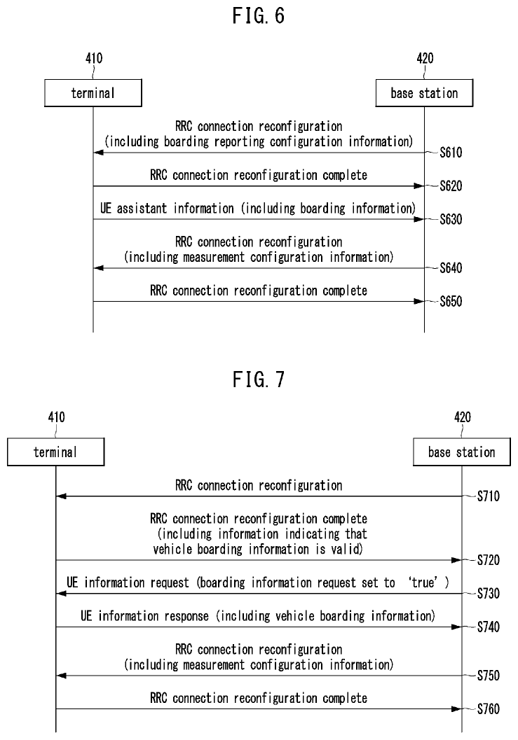

FIG. 6 is a sequence chart illustrating a procedure for accessing a base station installed in a vehicle by a terminal according to a first exemplary embodiment of the present disclosure.

Referring to FIG. 6, the base station 420 installed in the vehicle may transmit, to the terminal 410, boarding reporting configuration information for determining whether or not the terminal boards the vehicle. The terminal 410 may report vehicle boarding information of the terminal to the base station 420 based on the boarding reporting configuration information received from the base station 420. The base station 420 may transmit measurement configuration information to the terminal 410 based on the vehicle boarding information received from the terminal 410. The terminal 410 may perform signal measurement based on the measurement configuration information received from the base station 420. In addition, the terminal 420 may transmit a measurement report message to the base station 420 based on the received measurement configuration information. For convenience of description, although a procedure for the terminal 410 to receive system information from the base station 420 and establish an RRC connection with the base station is not described, the terminal 410 may perform a step (e.g., S410) of receiving system information from the base station 420 and step(s) (e.g., S420 to S440) for RRC connection establishment. Here, the measurement configuration information may vary for a case where the terminal boards the vehicle and a case where the terminal does not board the vehicle.

In a step S610, the base station 420 may transmit an RRC connection reconfiguration message including the boarding reporting configuration information (e.g., onbaordReportingConfig) to the terminal 410. The terminal 410 may receive the RRC connection reconfiguration message including the boarding reporting configuration information from the base station. Here, the RRC reconfiguration message may be a modified message or a newly defined message including the boarding reporting configuration information.

In a step S620, the terminal 410 may transmit an RRC connection reconfiguration complete message to the base station in response to the RRC connection reconfiguration message received from the base station 420.

In a step S630, when the terminal 410 boards the vehicle in which the base station 420 is installed, the terminal 410 may transmit a message including vehicle boarding information (e.g., onBoardInformation) to the base station 420. The base station 420 may receive the message including the vehicle boarding information from the terminal 410. On the other hand, when the terminal 410 does not board the vehicle in which the base station 420 is installed, the terminal 410 may not transmit a message including vehicle boarding information to the base station 420. Here, the message including the vehicle boarding information may be a UE assistance information message (e.g., UEAssistanceInformation message), and the UE assistance information message may be a modified message or a newly defined message. Alternatively, the message including the vehicle boarding information may be a message other than the UE assistance information message.

As a first exemplary embodiment, the terminal may determine that the terminal boards the vehicle when vehicle boarding information is valid for the vehicle in which the base station is installed. For example, before accessing the base station, the terminal may provide information on a cell of the vehicle to a user through a user interface, and the user may request access to the base station using the provided information. In this case, a higher layer (e.g., non-access stratum (NAS) layer) of the terminal may inform an RRC layer of the terminal that the terminal is in a state of boarding the vehicle in which the base station is installed. The RRC layer of the terminal may transmit a message including vehicle boarding information to the base station.

As a second exemplary embodiment, when a change in reception strength (e.g., SS_{RSRP}) of the base station for a predetermined time period is less than or equal to a specific threshold, the terminal may determine that itself is a terminal boarding the vehicle. When Equation 3 is satisfied, the terminal may determine that itself is a terminal boarding the vehicle.

isMobileCell AND [(SS_{RSRP}_{_{Ref}}−SS_{RSRP})<S_{SearchDeltaP}] [Equation 3]

Here, isMobileCell indicates whether the base station is in a moving state, SS_{RSRP}_{_{Ref}} indicates a reference SS_{RSRP}, and SS_{RSRP} indicates a reference signal received power (RSRP) measured through a demodulation reference signal (DMRS) within a physical broadcast channel (PBCH). In addition, S_{SearchDeltaP} represents a threshold for a difference between SS_{RSRP}_{_{Ref}} and SS_{RSRP}.

As a third exemplary embodiment, when a change in a difference (e.g., Ldiff) between the current location of the base station and the current location of the terminal is less than or equal to a threshold for a predetermined time, the terminal may be determined as a terminal boarding the vehicle.

As a fourth exemplary embodiment, when both a received signal strength change condition and a location difference change condition are satisfied or only one of the received signal strength change condition and the location difference change condition is satisfied, the terminal may be determined to be a terminal boarding the vehicle. Here, the location difference change condition may be the condition shown in Equation 2, and the received signal strength change condition may be the condition shown in Equation 3.

In a step S640, the base station 420 may transmit an RRC connection reconfiguration message including measurement configuration information (e.g., measConfig) to the terminal 410. The terminal 410 may receive the RRC connection reconfiguration message including the measurement configuration information from the base station 420. Here, the measurement configuration information may vary for a case where the terminal boards the vehicle in which the base station is installed and a case where the terminal does not board the vehicle in which the base station is installed.

The base station installed in the vehicle may determine whether or not the terminal boards the vehicle based on a UE assistance information message received from the terminal. The base station installed in the vehicle may generate measurement configuration information based on whether or not the terminal boards the vehicle, and transmit an RRC connection reconfiguration message including the measurement configuration information.

The terminal may configure a measurement information report based on the received measurement configuration information. The terminal may perform measurement reporting to the base station based on a configured measurement report.

In a step S650, the terminal may transmit an RRC connection reconfiguration complete message (e.g., RRCReconfigurationComplete message) to the base station 620 in response to the RRC connection reconfiguration.

Meanwhile, the terminal may transmit a message (e.g., RRC connection reconfiguration message) including information indicating that the vehicle boarding information is valid (e.g., onboard-InfoAvailable) to the base station. The base station may receive the message including the information indicating that the vehicle boarding information received from the terminal is valid, and may use the received message to determine whether or not the terminal boards the vehicle.

FIG. 7 is a sequence chart illustrating a procedure for accessing a base station installed in a vehicle by a terminal according to a second exemplary embodiment of the present disclosure.

Referring to FIG. 7, when accessing the base station 420 by boarding the vehicle in which the base station 420 is installed, the terminal may inform the base station 420 that vehicle boarding information is valid, and the base station 420 may request the terminal 410 to transmit the vehicle boarding information. The terminal 410 may transmit the vehicle boarding information to the base station 420, and the base station 420 may transmit measurement configuration information to the terminal 410 based on the vehicle boarding information. The terminal 410 may perform signal measurement based on the measurement configuration information received from the base station 420. In addition, the terminal 420 may transmit a measurement report message to the base station 420 based on the received measurement configuration information. For convenience of description, although a procedure for the terminal 410 to receive system information from the base station 420 and establish an RRC connection with the base station is not described, the terminal 410 may perform a step (e.g., S410) of receiving system information from the base station 420 and step(s) (e.g., S420 to S440) for RRC connection establishment. Here, the measurement configuration information may vary for a case where the terminal boards the vehicle and a case where the terminal does not board the vehicle.

In a step S710, the base station 420 may transmit an RRC connection reconfiguration message (e.g., RRCReconfiguration message) for reconfiguring the RRC connection to the terminal 410. The terminal 410 may receive the RRC connection reconfiguration message from the base station 420.

In a step S720, when vehicle boarding information is valid, the terminal 410 may transmit information (e.g., onboard-InfoAvailable) indicating that the vehicle boarding information is valid to the base station 420. The base station 420 may receive the information indicating that the vehicle boarding information is valid from the terminal 410. Here, the information indicating that the vehicle boarding information is valid may be included in an RRC connection reconfiguration complete message, and the RRC connection reconfiguration complete message may be a modified message or a newly defined message.

In a step S730, the base station 420 may transmit a boarding information request to the terminal 410, and the terminal 410 may receive the boarding information request from the base station 420. Here, the boarding information request may be included in a UE information request message (e.g., UEInformationRequest message), and the boarding information request may be set to ‘true’ (e.g., onboard-InfoReq set to ‘true’). Here, the UE information request message may be a modified message or a newly defined message including the boarding information request.

In a step S740, upon receiving the boarding information request from the base station 420, the terminal 410 may transmit a UE information response message (e.g., UEInformationResponse) including the vehicle boarding information (e.g., onboard-Info) to the base station 420. The base station 420 may receive the UE information response message including the vehicle boarding information from the terminal 410. Here, the UE information response message may be a modified message or a newly defined message including the vehicle boarding information.

In a step S750, the base station 420 may transmit an RRC connection reconfiguration message including measurement configuration information (e.g., measConfig) to the terminal 410. The terminal 410 may receive the RRC connection reconfiguration message including the measurement configuration information from the base station 420.

In a step S760, the terminal 410 may transmit an RRC connection reconfiguration complete message (e.g., RRCReconfigurationComplete message) to the base station 420 in response to the RRC connection reconfiguration.

The base station installed in the vehicle may determine whether or not the terminal boards the vehicle based on the UE information response message received from the terminal. The base station installed in the vehicle may generate measurement configuration information based on whether or not the terminal boards the vehicle, and transmit an RRC connection reconfiguration message including the measurement configuration information.

The terminal may configure a measurement information report based on the received measurement configuration information. The terminal may perform measurement reporting to the base station based on the configured measurement report. Here, the received measurement configuration information may vary according to whether the terminal boards the vehicle, as described above.

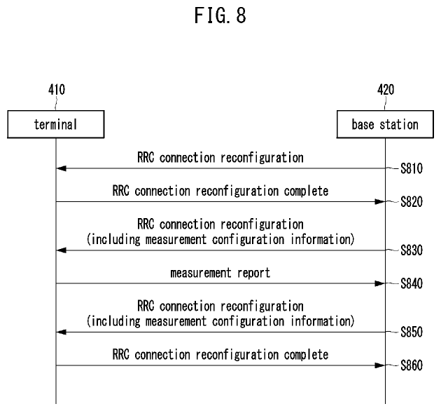

FIG. 8 is a sequence chart illustrating a procedure for accessing a base station installed in a vehicle by a terminal according to a third exemplary embodiment of the present disclosure.

Referring to FIG. 8, the base station 410 may transmit measurement configuration information to the accessing terminal 410 in order to determine whether or not the terminal boards the vehicle. The base station may transmit, to the terminal, measurement configuration information varying for a case where the terminal boards the vehicle and a case where the terminal does not board the vehicle. The terminal may be configured to measure a channel state with the base station based on the received measurement configuration information, and may measure the channel state. The terminal 410 may perform signal measurement based on the measurement configuration information received from the base station 420. When a measurement result reporting condition included in the measurement configuration information is satisfied, the terminal 410 may transmit a measurement report message to the base station 420. The base station 420 may determine whether the terminal boards the vehicle based on the measurement report message received from the terminal 410. The base station 420 may transmit different measurement configuration information to a terminal boarding the vehicle and a terminal not boarding the vehicle. For convenience of description, although a procedure for the terminal 410 to receive system information from the base station 420 and establish an RRC connection with the base station is not described, the terminal 410 may perform a step (e.g., S410) of receiving system information from the base station 420 and step(s) (e.g., S420 to S440) for RRC connection establishment. Here, the measurement configuration information may vary for a case where the terminal boards the vehicle and a case where the terminal does not board the vehicle.

Steps S810 to S820 may be performed according to an RRC connection establishment procedure.

In a step S830, the base station 420 may transmit an RRC connection reconfiguration message including measurement configuration information (e.g., measConfig) to the terminal 410 in order to determine whether or not the terminal 410 boards the vehicle. The terminal 410 may receive the RRC connection reconfiguration message including the measurement configuration information from the base station 420.

The terminal may configure signal measurement based on the received measurement configuration information, and may perform signal measurement based on the configured signal measurement. Here, the measurement configuration information may include a measurement result reporting condition for determining whether the terminal boards the vehicle.

As an exemplary embodiment, the measurement result reporting condition may be a case where the base station is in a moving state and a change in received signal strength of the base station is less than or equal to a specific threshold for a predetermined time.

As another exemplary embodiment, the measurement result reporting condition may be a case where the base station is in a moving state and a change in a difference between the current location of the corresponding base station and the current location of the terminal is less than or equal to a specific threshold for a predetermined period.

As yet another exemplary embodiment, the measurement result reporting condition may be a case where both the received signal strength change condition and the location difference change condition are satisfied.

When the movement speed and cell coverage information of the moving base station are valid for cell selection/reselection and handover, a terminal that does not board the vehicle or a terminal that is determined not to board the vehicle may be prevented from performing unnecessary cell access to the moving base station. A terminal that does not board the vehicle or a terminal that is determined not to board the vehicle may calculate a time (hereinafter, ‘cell accessible time’) for which the terminal can access the base station installed in the vehicle based on the movement speed and cell coverage information of the base station installed in the vehicle.

As an exemplary embodiment, when the calculated cell accessible time is less than or equal to a specific threshold, the terminal may exclude an accessible cell in the base station installed in the vehicle from candidate cells for cell selection/reselection and handover.

As another exemplary embodiment, when the movement speed of the base station installed in the vehicle is equal to or higher than a specific threshold, the terminal may exclude an accessible cell in the base station installed in the vehicle from candidate cells for cell selection/reselection and handover. The base station may provide configuration information required for the terminal to perform the above-describe determination.

Improved Methods for a Terminal to Measure Signal Strengths

The terminal may periodically measure signal strengths of a serving cell and neighboring cells. Since a battery is consumed when measuring the signal strengths, the signal strength measurement should be performed as little as possible. However, if a proper handover timing is missed due to too little signal strength measurements, a handover failure may occur, and when a handover failure occurs, an interruption time may increase and a communication quality may rapidly deteriorate. Accordingly, battery consumption may be reduced by not measuring the signal strengths of neighboring cells when the signal strength of the serving cell is greater than a specific threshold.

When the base station installed in the vehicle moves, the signal strength measured by the terminal boarding the vehicle with respect to the base station installed in the vehicle may almost always be higher than a certain level. Therefore, the terminal may reduce battery consumption by not measuring the signal strength of neighboring base stations by setting a specific threshold in measuring the signal strengths for the base stations. However, if a surrounding terminal not on the vehicle sets a specific threshold in measuring the signal strengths of base stations, there may be a high possibility of missing an appropriate handover timing to a neighboring base station, and there may be a problem in that the probability of handover failure increases. Therefore, a terminal boarding the vehicle and a surrounding terminal not boarding the vehicle may need to set different thresholds in measuring the signal strength of the base station installed in the vehicle, so that the signal strengths of the neighboring base stations are not measured.

As an exemplary embodiment, the base station installed in the vehicle may set different specific thresholds in signal strength measurement for a terminal boarding the vehicle and a neighboring terminal not boarding the vehicle. The terminal may receive configuration information of the specific thresholds, and may set the specific threshold in signal strength measurement based on whether or not the terminal boards the vehicle in which the base station is installed.

As another exemplary embodiment, the base station installed in the vehicle may determine whether an accessing terminal is a terminal boarding the vehicle or a neighboring terminal not boarding the vehicle based on information on whether the accessing terminal boards the vehicle, which is received from the accessing terminal, and set a specific threshold in signal strength measurement. The base station installed in the vehicle may transmit measurement configuration information including the specific threshold in signal strength measurement to the accessing terminal. The terminal may configure signal measurement based on the measurement configuration information including the specific threshold in signal strength measurement. Here, the terminal may determine whether or not the terminal boards the vehicle in which the base station is installed and transmit the information on whether the terminal boards the vehicle to the base station.

As another exemplary embodiment, the base station installed in the vehicle may request information for determining whether an accessing terminal is a terminal boarding the vehicle or a neighboring terminal not boarding the vehicle. The accessing terminal may transmit, to the base station, information for determining whether or not the accessing terminal boards the vehicle in response to the received request. Here, the information for determining whether or not the accessing terminal boards the vehicle may include the location of the terminal, movement speed of the terminal, signal strength measurement result for the base station installed in the vehicle, and the like.

Improved Method for Handover of a Terminal

The terminal may receive, from the base station, configuration information for a target cell to which the terminal is to hand over and handover execution condition configuration information for performing a handover when a specific condition is satisfied. The existing handover execution condition configuration information may include an A3 event, A5 event, A4 event, D1 event, and T1 event. The T1 event may be represented as shown in Table 5.

Table 5 is an example showing an exemplary embodiment of the T1 event.

TABLE 5

| | |
|---|---|
| condEventT1-r17 | SEQUENCE { |
| t1-Threshold-r17 | INTEGER (0..549755813887), |
| duration-r17 | INTEGER (1..6000) |

}

Referring to Table 5, the T1 event (e.g., condEventT1-r17) may be a conditional handover event that is satisfied when the current time is included in a specific time period. The T1 event (e.g., condEventT1-r17) may include a threshold t1-threshold (e.g., t1-Threshold-r17) parameter and a duration parameter.

According to the T1 event, a handover execution condition may be satisfied when a measured time is greater than the threshold t1-Threshold and less than (t1-Threshold+duration). On the other hand, when the measured time is greater than (t1-Threshold+duration), the conditional handover configuration information may be invalid because an event leaving condition is satisfied.

Meanwhile, when the base station operates an intermittent cell due to energy saving or movement of the base station, a handover execution condition may be configured such that the terminal performs a handover unconditionally until a specific time point. Accordingly, the handover execution condition configuration information may include a T2 event for unconditionally performing a handover. The T2 event may include a threshold t2-Threshold and a related timer (e.g., timer Tt2).

A T2 event entering condition may be satisfied when a measured time is greater than the threshold t2-Threshold. When the T2 event is satisfied, the timer Tt2 may be operated. A handover execution time point may be autonomously determined by the terminal, and the terminal may perform a handover before the timer Tt2 expires. When the timer Tt2 expires, the terminal may immediately perform a handover. Even after the timer Tt2 expires, the T2 event entering condition is still satisfied, so the conditional handover configuration information for the T2 event may continue to be valid.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a first message including state information of a base station from the base station;
identifying preliminary inactive state information included in the first message when the state information of the base station indicates a preliminary inactive state; and
performing a cell selection based on the preliminary inactive state information.

2. The method according to claim 1, wherein the preliminary inactive state information includes at least one of an inactive state start time, an inactive state duration time, or a preliminary inactive offset.

3. The method according to claim 1, wherein when the preliminary inactive state information includes the preliminary inactive offset, a cell is selected in consideration of the preliminary inactive offset.

4. The method according to claim 1, further comprising:
identifying inactive state information included in the first message when the state information of the base station indicates an inactive state; and
performing a cell selection based on the inactive state information.

5. The method according to claim 4, wherein the inactive state information includes at least one of an inactive state start time, an inactive state duration time, an active state start time, or an inactive offset.

6. The method according to claim 5, wherein when the inactive state information includes the inactive offset, a cell is selected in consideration of the inactive offset.

7. The method according to claim 1, further comprising:
identifying energy saving state information included in the first message when the state information of the base station indicates an energy saving state; and
performing a cell selection based on the energy saving state information.

8. The method according to claim 7, wherein the energy saving state information includes at least one of an energy saving offset or an energy saving scheme.

9. The method according to claim 8, wherein when the energy saving state information includes the energy saving offset, a cell is selected in consideration of the energy saving offset.

10. The method according to claim 1, further comprising:
generating a first message for notifying that there is no other cell that satisfies cell selection criteria when there is no other cell that satisfies the cell selection criteria except for the base station to which the terminal is currently accessing; and
transmitting the first message to the base station.

11. A method of a base station, comprising:
generating a first message including state information of the base station; and
transmitting the first message to a terminal,
wherein when the state information of the base station indicates a preliminary inactive state, the first message includes at least one of an inactive state start time, an inactive state duration time, or a preliminary inactive offset.

12. The method according to claim 11, wherein when the state information of the base station indicates an inactive state, the first message includes at least one of an inactive state start time, an inactive state duration time, an active state start time, or an inactive offset for cell selection.

13. The method according to claim 11, wherein when the state information of the base station indicates an energy saving state, the first message includes at least one of an energy saving offset or an energy saving scheme.

14. The method according to claim 11, wherein the first message is at least one of a system information message broadcast by the base station, a system message transmitted to the terminal, or a dedicated message transmitted to the terminal.

15. A terminal comprising a processor,
wherein the processor causes the terminal to perform:
receiving a first message including state information of a base station from the base station;
identifying preliminary inactive state information included in the first message when the state information of the base station indicates a preliminary inactive state; and
performing a cell selection based on the preliminary inactive state information.

16. The terminal according to claim 15, wherein the preliminary inactive state information includes at least one of an inactive state start time, an inactive state duration time, or a preliminary inactive offset.

17. The terminal according to claim 15, wherein the processor further causes the terminal to perform:
identifying inactive state information included in the first message when the state information of the base station indicates an inactive state; and
performing a cell selection based on the inactive state information.

18. The terminal according to claim 17, wherein the inactive state information includes at least one of an inactive state start time, an inactive state duration time, an active state start time, or an inactive offset.

19. The terminal according to claim 15, wherein the processor further causes the terminal to perform:
identifying energy saving state information included in the first message when the state information of the base station indicates an energy saving state; and
performing a cell selection based on the energy saving state information.

20. The terminal according to claim 19, wherein the energy saving state information includes at least one of an energy saving offset or an energy saving scheme.
